(19) United States
(12) Patent Application Publication
(10) Pub. No.: US 2014/0214367 A1
(43) Pub. Date: Jul. 31, 2014

(54) METHOD AND SYSTEM FOR TESTING LIGHT LEAKAGE OF DISPLAY DEVICE

(71) Applicants: Hon Hai Precision Industry Co., Ltd., New Taipei (TW); Fu Tai Hua Industry (Shenzhen) Co., Ltd., Shenzhen (CN)

(72) Inventor: MING-YUE TONG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/162,712

(22) Filed: Jan. 23, 2014

(30) Foreign Application Priority Data
Jan. 28, 2013 (CN) 2013100298092

(51) Int. Cl. G01N 21/17

(52) U.S. Cl. CPC G01N 21/17
USPC 702/189

(57) ABSTRACT

A light leakage testing method for a display device involves obtaining a brightness value of each pixel of a display device to be tested, and then dividing the display device into a plurality of testing points, each testing point comprising a plurality of adjacent pixels defining the testing points located on a centre of the display device as a reference area and the testing points surrounding the reference area as a plurality of testing areas. Calculating a ratio by obtaining a difference value of each testing point of the testing area and the brightness value of the reference area to the brightness value of the reference area, and when the ratio is greater than a predetermined value, the display device has light leakage

### BACKGROUND

1. Technical Field

The present disclosure relates to testing technologies, and more particularly, to a method and a system for testing light leakage of a display device.

2. Description of Related Art

Display devices are widely used in electronic devices, such as mobile phones, tablet computers, or portable media players. A display device utilizes a light source to illuminate a display panel; however, light emitted by the light source may leak from a periphery of the display panel when the display panel is not tightly assembled to a frame, this phenomenon is called light leakage. Accordingly, light leakage testing needs to be performed on the display device after assembly. In a typical light leakage testing process, a tester manually detects whether the display device suffers light leakage; however, a test accuracy of the manual testing process is somewhat low and the test result may be unreliable.

Therefore, what is needed is a means to overcome the above-described shortcoming.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic block diagram of a light leakage testing device having a light leakage testing system for testing light leakage of a display device.

FIG. 2 illustrates an arrangement of a reference area and testing areas of the display device of FIG. 1.

FIG. 3 is a flow chart of a method for testing light leakage of the display device according to an embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

Reference will be made to the drawings to describe various embodiments.

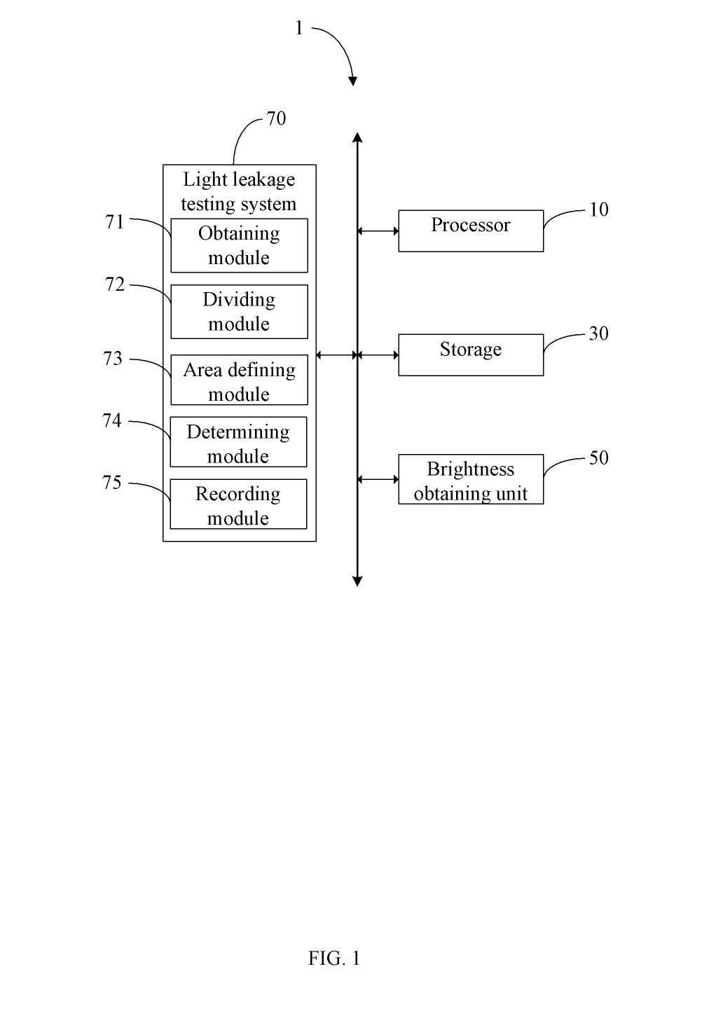

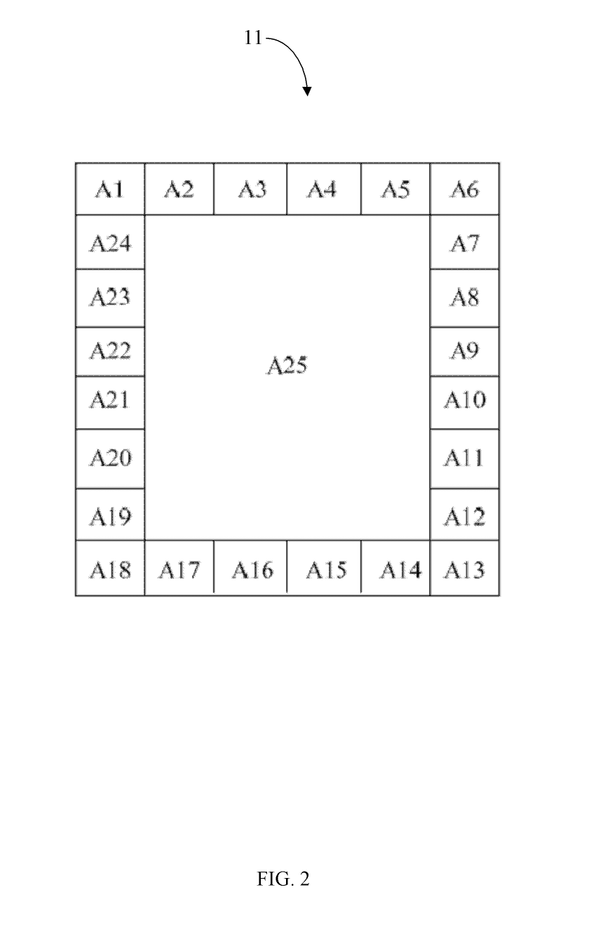

FIG. 1 shows a schematic block diagram of a light leakage testing device 1 having a light leakage testing system 70 for testing light leakage of a display device 11 (as shown in FIG. 2). FIG. 2 shows an arrangement of a reference area and testing areas of the display device 11. FIG. 1 shows one example of the light leakage testing device 1, and the light leakage testing device 1 can include more or fewer components than those shown in the embodiment, or have a different configuration of the components. The light leakage testing device 1 includes a processor 10, a storage 30, a brightness obtaining unit 50, and the light leakage testing system 70 for testing light leakage of the display device 11. The light leakage testing device 1 can be, but is not limited to be, an industry camera, and the brightness obtaining unit 50 can be installed on a lens module of the industry camera. During testing process, the brightness obtaining unit 50 is aligned with a screen of the display device 11 to obtain a brightness value of each pixel of the display device 11.

The light leakage testing system 70 includes an obtaining module 71, a dividing module 72, an area defining module 73, a determining module 74, and a recording module 75. In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The obtaining module 71 obtains a brightness value of each pixel of the display device 11 to be tested. In detail, the obtaining module 71 outputs a control command to the brightness obtaining unit 50 to control the brightness obtaining unit 50 to obtain the brightness value of each pixel of the display device 11. In the embodiment, the display device 11 is arranged in a dark space and a color of the display device 11 is set as a single color, such as white. A luminance of the display device 11 is set to maximum.

The dividing module 72 divides the display device 11 into a plurality of testing points, each testing point includes a plurality of adjacent pixels. The dividing module 72 also obtains a brightness value of the testing point by calculating the brightness values of the corresponding plurality of adjacent pixels. In the embodiment, the brightness value of each testing point is an average brightness value of the plurality of adjacent pixels.

The area defining module 73 defines ones of testing points located on a centre of the display device 11 as a reference area and defines ones of testing points surrounding the reference area as a plurality of testing areas. In the embodiment, a size of the reference area is half of the display device 11, and a center point of the reference area is a center point of the display device 11.

In the embodiment, the area defining module 73 defines the display device 11 to twenty five areas, labeled as A1-A25 sequentially. The area A25 is in a center of the display device 11 and defined as the reference area. The areas A1-A24 are defined as testing areas. In general, a marginal area of the display device 11 generates light leakage, therefore, the center of the display device 11 is the reference area to determine whether the marginal area generates light leakage.

The determining module 74 determines whether the testing area has light leakage by comparing the brightness value of each testing point of the testing area with a brightness value of the reference area. In detail, the determining module 74 calculates a difference value between the brightness value of each testing point of the testing area and the brightness value of the reference area and a ratio of the difference value to the brightness value of the reference area. When the ratio of one testing point is greater than a predetermined value, the determining module 74 determines that the display device 11 has light leakage. The predetermined value is stored in the storage 30. In addition, the determining module 74 determines whether the reference area has light leakage by comparing the brightness value of the reference area with a predetermined maximum brightness value. When the brightness value of the reference area is less than the predetermined maximum brightness value, the determining module 74 determines that the display device 11 has light leakage.

The recording module 75 records location information of the testing area which has light leakage in the storage 30. The location information includes a number of the testing areas, which has light leakage, and a ratio of the brightness value of the testing area which has light leakage to the brightness value of the reference area. When the reference area generates light leakage, the recording module 75 records the brightness value of the reference area in the storage 30.

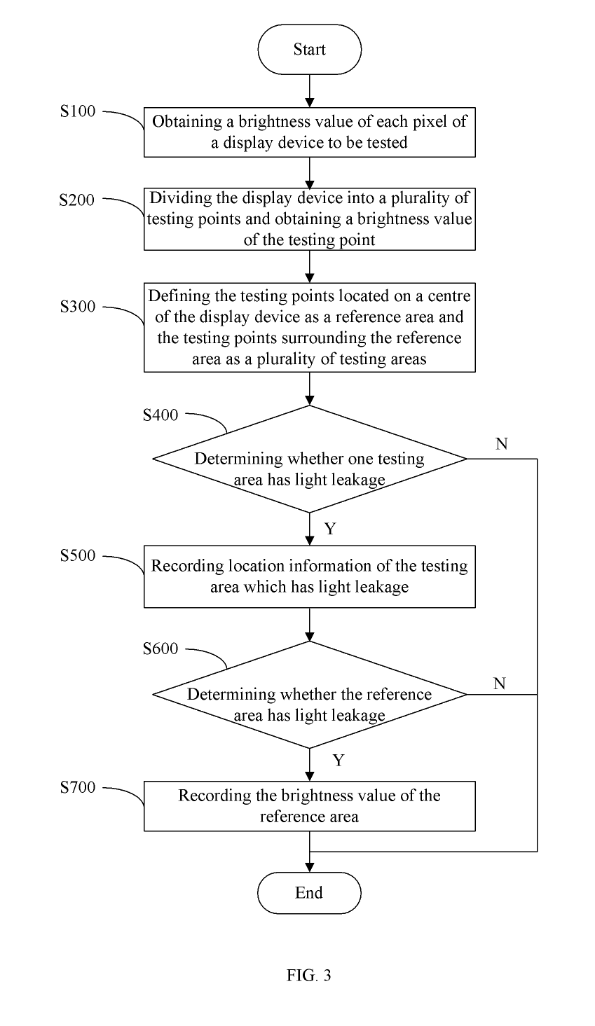

FIG. 3 shows a flowchart of one embodiment of a method for testing light leakage of a display device 11. Depending on the embodiment, additional steps may be added, others removed, and the ordering of the steps may be changed.

In step S100, the obtaining module 71 obtains a brightness value of each pixel of the display device 11 to be tested.

In step S200, the dividing module 72 divides the display device 11 into a plurality of testing points, each testing point includes a plurality of adjacent pixels. The dividing module 72 also obtains a brightness value of the testing point by calculating the brightness values of the corresponding plurality of adjacent pixels.

In step S300, the area defining module 73 defines the testing points located on a centre of the display device 11 as a reference area and defines the testing points surrounding the reference area as a plurality of testing areas. In the embodiment, a size of the reference area is half of the display device 11, and a central point of the reference area is a central point the display device 11.

In step S400, the determining module 74 determines whether one testing area has light leakage by comparing the brightness value of each testing area of the testing area with a brightness value of the reference area. When one testing area generates light leakage, step S500 is performed; when no testing area generates light leakage, the method of testing light leakage is ended.

In step S500, the recording module 75 records location information of the testing area which has light leakage in the storage 30. The location information includes a number of the testing areas, which has light leakage, and a ratio of the brightness value of the testing areas which has light leakage, to the brightness value of the reference area. The recording module 75 records the brightness value of the reference area in the storage 30.

In step S600, the determining module 74 further determines whether the reference area has light leakage by comparing the brightness value of the reference area with a predetermined maximum brightness value, when the brightness value of the reference area is less than the predetermined maximum brightness value, the determining module 74 determines that the display device 11 has light leakage. When the reference area generates light leakage, step S700 is performed; when the reference area does not generate light leakage, the method of testing light leakage is ended.

In step S700, the recording module 75 records the brightness value of the reference area in the storage 30.

It is to be understood that even though numerous characteristics and advantages of the present embodiments have been set forth in the foregoing description, with details of the structures and functions of the embodiments, the disclosure is illustrative only; and changes may be in detail, especially in the matters of arrangement of parts within the principles of the embodiments to the full extent indicated by the broad general meaning of the terms in which the appended claims are expressed.

What is claimed is:

1. A light leakage testing device, comprising:
a processor;
a brightness obtaining unit;
a storage; and
one or more programs stored in the storage and executed by the processor, the one or more programs comprising:
an obtaining module obtaining a brightness value of each pixel of a display device to be tested;
a dividing module dividing the display device into a plurality of testing points, each testing point comprising a plurality of adjacent pixels, and obtaining a brightness value of the testing point by calculating the brightness values of the corresponding plurality of adjacent pixels;
an area defining module defining ones of the testing points located on a centre of the display device as a reference area and ones of the testing points surrounding the reference area as a plurality of testing areas; and
a determining module determining whether one testing area has light leakage by comparing the brightness value of each testing point of each testing area with a brightness value of the reference area.

2. The light leakage testing device of claim 1, wherein the brightness value of each testing point is an average brightness value of the plurality of adjacent pixels of the testing point, and the brightness value of the reference area is an average brightness value of the plurality of the testing points of the reference area.

3. The light leakage testing device of claim 1, wherein the determining module calculates a difference value between the brightness value of each testing point of each testing area and the brightness value of the reference area and a ratio of the difference value to the brightness value of the reference area; when the ratio of one testing point is greater than a predetermined value, the determining module determines that the display device has light leakage.

4. The light leakage testing device of claim 3, wherein the one or more programs further comprises a recording module, the recording module records location information of the testing area which has light leakage and a ratio of the brightness value of the testing area which has light leakage to the brightness value of the reference area in the storage.

5. The light leakage testing device of claim 4, wherein the determining module determines whether the reference area has light leakage by comparing the brightness value of the reference area with a predetermined maximum brightness value, when the brightness value of the reference area is less than the predetermined maximum brightness value, the determining module determines that the display device has light leakage.

6. The light leakage testing device of claim 5, wherein when the reference area generates light leakage, the recording module records the brightness value of the reference area in the storage.

7. A method for testing light leakage of a display device, the method comprising:
obtaining a brightness value of each pixel of the display device to be tested;
dividing the display device into a plurality of testing points, each testing point comprising a plurality of adjacent pixels and obtaining a brightness value of the testing point by calculating the brightness values of the corresponding plurality of adjacent pixels;
defining ones of testing points located on a centre of the display device as a reference area and ones of testing points surrounding the reference area as a plurality of testing areas; and
determining whether one testing area has light leakage by comparing the brightness value of each testing point of each testing area with a brightness value of the reference area.

8. The method of claim 7, wherein the brightness value of each testing point is an average brightness value of the plurality of adjacent pixels of the testing point, and the brightness value of the reference area is an average brightness value of the plurality of the testing points of the reference area.

9. The method of claim 7, wherein the determining step comprises calculating a difference value between the brightness value of each testing point of each testing area and the brightness value of the reference area and a ratio of the difference value to the brightness value of the reference area; when the ratio of one testing point is greater than a predetermined value, the display device has light leakage.

10. The method of claim 9, further comprising recording location information of the testing area which has light leakage and a ratio of the brightness value of the testing area which has light leakage to the brightness value of the reference area.

11. The method of claim 7, wherein the determining step comprises determining whether the reference area has light leakage by comparing the brightness value of the reference area with a predetermined maximum brightness value, when the brightness value of the reference area is less than the predetermined maximum brightness value, the display device has light leakage.

12. The method of claim 11, wherein when the reference area generates light leakage, recording the brightness value of the reference area.
